(19) United States
(12) Patent Application Publication
(10) Pub. No.: US 2010/0086779 A1
(43) Pub. Date: Apr. 8, 2010

(54) SPLITTABLE CONJUGATE FIBER INCLUDING POLYACETAL, AND FIBROUS FORM AND PRODUCT EACH OBTAINED FROM THE SAME

(75) Inventors: Yukiharu Shimotsu, Osaka (JP); Minoru Miyauchi, Osaka (JP)

Correspondence Address: HAMRE, SCHUMANN, MUELLER & LARSON, P.C., P.O. BOX 2902, MINNEAPOLIS, MN, 55402-0902, US

(73) Assignees: ES FIBERVISIONS CO., LTD., Osaka-shi, Osaka (JP); ES FIBERVISIONS HONG KONG LIMITED, Kowloon (HK); ES FIBERVISIONS LP, Athens, GA (US); ES FIBERVISIONS APS, Varde (DK)

(21) Appl. No.: 12/532,027

(22) PCT Filed: Mar. 19, 2008
(86) PCT No.: PCT/JP2008/055811

§ 371 Date: Nov. 12, 2009

(30) Foreign Application Priority Data
Mar. 20, 2007 (JP) 2007-073221
Dec. 25, 2007 (JP) 2007-332295

(51) Int. Cl. D01F 8/06; D01F 8/16; C08G 4/00

(52) U.S. Cl. 428/364; 525/185

(57) ABSTRACT

The invention provides a splittable conjugate fiber excellent in splittability and chemical resistance. The invention also provides a fibrous form and product comprising the fiber with satisfactory productivity. A splittable conjugate fiber comprising a polyacetal and a polyolefin (e.g., polypropylene, polyethylene or the like), wherein the polyacetal satisfies the following numerical expression: Tc′=144° C. [wherein Tc′ represents the crystallization temperature Tc (° C.) when cooling the polyacetal melted at 210° C. at a cooling rate of 10° C./min].

### TECHNICAL FIELD

The present invention relates to a splittable conjugate fiber including a polyacetal and having excellent splittability. More particularly, the invention relates to a splittable conjugate fiber suitable for use in, e.g., the field of industrial materials such as battery separators, wipers, and filters and the field of hygienic materials such as diapers and napkins, and to a fibrous form and a product each obtained from the conjugate fiber.

### BACKGROUND ART

Use of conjugate fibers of a sea-island type or split type has conventionally been known as a technique for obtaining microfibers.

A method of obtaining a sea-island type conjugate fiber is to spin a combination of two or more ingredients. Removing one component of the resultant sea-island type conjugate fiber by dissolution gives microfibers. Although this technique can yield exceedingly fine fibers, it is not economical because one component is removed by dissolution.

On the other hand, a method of obtaining a splittable conjugate fiber is to spin a combination of two or more resins. The splittable conjugate fiber obtained is split into many fibers by applying a physical stress thereto or utilizing, e.g., a difference in contraction with a chemical between the resins. Thus, microfibers are obtained.

Known splittable conjugate fibers include, for example, ones constituted of a combination of a polyester resin and a polyolefin resin, combination of a polyester resin and a polyamide resin, or combination of a polyamide resin and a polyolefin resin (see patent documents 1 and 2). These conjugate fibers split by physical stress. However, the polyester and the polyamide have low chemical resistance and, hence, the microfibers obtained therefrom by splitting and fibrous forms comprising the microfibers have limited uses in the field of industrial materials required to have chemical resistance.

On the other hand, in the case of a combination of polyolefin resins having excellent chemical resistance, it has been necessary to use higher physical impact for splitting into finer fibers because the combination of polyolefin resins has more compatibility than those combinations of different kinds of polymers. However, for subjecting to an advanced high-pressure liquid jets treatment, it is necessary to cause the fiber to reside in a treatment apparatus for a commensurate time period. This has necessitated a considerable reduction in processing rate or an enlargement of the apparatus for the high-pressure liquid jets treatment. In addition, the microfibers thus obtained are not satisfactory at all, for example, because the split fibers obtained by pressing by high physical impact give a nonwoven fabric which is uneven and has a poor texture.

A technique for mitigating that problem is disclosed in patent document 3, in which, in forming a splittable conjugate fiber comprising polymers of the same kind, organosiloxanes and modifications thereof are added to cause to be present at least at the interface between the ingredients constituting the fiber, whereby this fiber can be easily split. However, although this fiber has somewhat improved splittability, the resultant split fibers have many problems due to influences of the releasability improved by the organosiloxane, for example, a reduction of thermal bondability, a reduction of nonwoven-fabric strength, and an occurrence of processing failures in secondary processing.

Patent document 4 discloses a splittable conjugate fiber which comprises at least two polyolefin ingredients and has a hollow. This conjugate fiber has specific values of: a proportion of a hollow; and a ratio of an average length W of the peripheral arcs of each polyolefin ingredient as a component of the fiber to an average thickness L extending from the hollow to the fiber periphery (W/L). There is a statement therein to the effect that due to this constitution, the conjugate fiber has excellent splittability. However, the splittability of the fiber, although improved, is not yet fully satisfactory. In order to efficiently obtain microfibers by using the splittable conjugate fiber while attaining a high degree of splitting, it is necessary to conduct a properly advanced splitting operation.

Furthermore, patent document 5 specifically discloses a splittable conjugate fiber for cement reinforcement which comprises a polyacetal and a polymethylpentene copolymer. There is a statement therein to the effect that this conjugate fiber has excellent dispersibility in cement slurries and is suitable for cement reinforcement. An examination of this polyacetal for crystallization temperature revealed that the crystallization temperature thereof was 145° C. Although this split fiber has excellent dispersibility in cement slurries, the fiber has poor spinnability and it is difficult to efficiently produce as a fiber for a fibrous-form production.

[Patent Citation 1] JP-A-62-133164

[Patent Citation 2] JP-A-2000-110031

[Patent Citation 3] JP-A-4-289222

[Patent Citation 4] Japanese Patent No. 3309181

[Patent Citation 5] JP-A-2002-29793

### DISCLOSURE OF INVENTION

### Technical Problem

As described above, investigations for obtaining a splittable conjugate fiber excellent in splittability and chemical resistance are being made by two routes, i.e., selection of the kinds of polymers as materials and improvement in fiber sectional shape. However, the splittable conjugate fibers obtained by the existing methods are unsatisfactory in splittability, chemical resistance, or spinnability. Objects of the invention is to eliminate the problems described above and provide with satisfactory productivity a splittable conjugate fiber excellent in splittability and chemical resistance, fibrous form and product each comprising the same.

### Technical Solution

The present inventors diligently made investigations in order to overcome the problems described above. As a result, they have found that those objects are accomplished with a specific splittable conjugate fiber comprising a polyacetal and a polyolefin. The invention has been thus completed.

Namely, the invention includes the following constitutions.

(1) A splittable conjugate fiber comprising a polyacetal and a polyolefin, wherein the polyacetal satisfies the following numerical expression:

Tc′≦144° C.

[wherein Tc′ represents the crystallization temperature Tc (° C.) when cooling the polyacetal melted at 210° C. at a cooling rate of 10° C./min].

(2) The splittable conjugate fiber as described under (1) above, wherein the polyolefin is polypropylene.

(3) The splittable conjugate fiber as described under (1) above, wherein the polyolefin is polyethylene.

(4) The splittable conjugate fiber as described under any one of (1) to (3) above, which has a hollow.

(5) A fibrous form comprising microfibers having an average single-yarn fineness after splitting of smaller than 0.6 dtex, wherein the microfibers are obtained by splitting the splittable conjugate fiber as described under any one of (1) to (4) above.

(6) The fibrous form as described under (5) above, wherein 50% or more of the splittable conjugate fiber is split.

(7) A product obtained using the fibrous form as described under (5) or (6) above.

### ADVANTAGEOUS EFFECTS

The splittable conjugate fiber of the invention has the following advantages because it is a specific splittable conjugate fiber comprising a polyacetal and a polyolefin. The splittable conjugate fiber has excellent splittability. Even when split with low physical impact, the fiber can be easily split into finer fibers without especially necessitating the addition of an additive at all for facilitating splitting. In addition, this splittable conjugate fiber has excellent chemical resistance, and the raw material has excellent spinnability. Consequently, the splittable conjugate fiber and the fibrous form and product obtained from the fiber have excellent productivity. Fibrous forms which are dense and have a satisfactory texture can be obtained from the splittable conjugate fiber of the invention. Products of such fibrous forms are suitable for use not only in the field of hygienic materials such as diapers and napkins, but also in the field of industrial materials such as battery separators, wipers, and filters.

### BRIEF DESCRIPTION OF DRAWINGS

FIG. 1 is a diagrammatic cross-sectional view of one embodiment of the splittable conjugate fiber for use in the invention.

FIG. 2 is a diagrammatic cross-sectional view of another embodiment of the splittable conjugate fiber for use in the invention.

FIG. 3 is a diagrammatic cross-sectional view of still another embodiment of the splittable conjugate fiber for use in the invention.

FIG. 4 is a diagrammatic cross-sectional view of one embodiment of the splittable conjugate fiber having a hollow for use in the invention.

FIG. 5 is a diagrammatic cross-sectional view of another embodiment of the splittable conjugate fiber having a hollow for use in the invention.

FIG. 6 is a diagrammatic cross-sectional view of still another embodiment of the splittable conjugate fiber having a hollow for use in the invention.

### EXPLANATION OF REFERENCE

1 one resin component (e.g., polyacetal)
2 another resin component (e.g., polyolefin)
3 hollow
d distance between fiber center and fiber surface
r distance between fiber center and projection tip of one resin component which is not exposed in fiber surface

### BEST MODE FOR CARRYING OUT THE INVENTION

The invention will be explained below in detail based on embodiments of the invention.

The splittable conjugate fiber of the invention comprises two components, i.e., a polyacetal and a polyolefin, as stated above.

Polyacetals include two kinds, i.e., homopolymers comprising generally 1,000 or more oxymethylene units, and copolymers comprising ethylene units in a polyoxymethylene main chain. Although the polyacetal used in the invention is not particularly limited, copolymers are preferred from the standpoint of thermal stability. Polyacetals containing 1 to 10 mol % ethylene units therein are suitable. In particular, one containing 1 to 4 mol % ethylene units is preferred. The presence of 1 mol % or larger ethylene units in the polyacetal improves the thermal stability of the polyacetal, while of the presence of 10 mol % or smaller ethylene units in the polyacetal enables the splittable conjugate fiber to have satisfactory strength. The polyacetal contained in the splittable conjugate fiber of the invention has a crystallization temperature Tc′, when cooling at a cooling rate of 10° C./min after melting at 210° C., of 144° C. or lower, preferably in the range of 136 to 144° C., especially preferably 138 to 142° C. Although polyacetals have excellent crystallizability, they have the following drawback in extrusion molding, in particular, melt spinning. The polyacetal filament rapidly solidifies in an upstream area (near the spinning nozzle). As a result, since the deformation rate in the period from discharge to solidification and the subsequent completion of thickness reduction becomes exceedingly high, the spinnability deteriorates. However, a polyacetal having a Tc′ of 144° C. or lower is prevented from rapidly solidifying and can retain spinnability. On the other hand, when the Tc′ of this polyacetal is 136° C. or higher, a sufficient stress is applied to the resin at the solidification point to grow a fiber structure. Because of this, the excellent splittability which is required of the fiber of the invention is apt to be obtained. Furthermore, from the standpoint of spinnability, a polyacetal more preferred is one which satisfies the requirement that when the crystallization temperature Tc (° C.) is plotted against logV, i.e., the logarithm of the cooling rate V (° C./min) of the polyacetal melted at 210° C., then the resultant graph has an inclination A of from −13 to −4, especially preferably from −11 to −6, and which has the Tc′ of 144° C. or lower, preferably 136 to 144° C., especially preferably 138 to 142° C. When the inclination A of the graph is −4 or lower and the Tc′ is 144° C. or lower, then this polyacetal is prevented from rapidly solidifying and is apt to bring about satisfactory spinnability. On the other hand, when the inclination A of the graph is −13 or higher and the Tc′ is 136° C. or higher, then a sufficient stress is applied to the resin at the solidification point to grow a fiber structure, whereby the excellent splittability required of the fiber of the invention is apt to be obtained. Moreover, a polyacetal in which the amount of heat of crystallization per 1 g of the polyacetal resin Qc (J/g) at a logV of 1 is 90 to 125 J/g, especially preferably 95 to 120 J/g, can be suitably used from the standpoints of spinnability, stretchability, and splittability. When a polyacetal having the Qc of 125 J/g or lower is used, then the unstretched yarn obtained by melt spinning contains a sufficient amount of tie molecules necessary for securing stretchability and can hence be stretched in a higher ratio. Thus, the splittability required of the fiber of the invention can be easily obtained. On the other hand, when a polyacetal having the Qc of 95 J/g or higher is used, then melt tension is secured and suitable spinnability is maintained. Thus, high productivity is realized. Such polyacetals suitable for melt spinning can be obtained by selecting a comonomer ingredient proportion in the resin or a molecular structure, or by selecting the kind and amount of an additive. The melt flow rate (hereinafter abbreviated to MFR) of such polyacetals which are suitable for use is not particularly limited as long as spinning is possible. However, the MFR thereof is preferably 1 to 90 g/10 min, more preferably 5 to 40 g/10 min, from the standpoint of spinnability. Polyacetals having an MFR of 1 g/10 min or higher are preferred from the standpoints of spinnability and stretchability because of the reduction of melt tension. The values of MFR of not higher than 90 g/10 min are more preferred because use of this polyacetal gives a fiber in which adjoining components are regularly arranged and which can be split into finer fibers to a desired level by physical stress, and because spinnability can be simultaneously maintained to attain high productivity. A melting point of such polyacetal is preferably 120 to 200° C., especially preferably 140 to 180° C., from the standpoint of spinnability. Such polyacetals are commercially available from several companies under the trade names of, e.g., “Tenac”, “Ultraform”, “Delrin”, “Duracon”, “Amirus”, “Hostaform”, and “Yubital”. One suitable for use in this invention can be selected from these.

On the other hand, examples of the polyolefin include polyethylene, polypropylene, polybutene-1, polyoctene-1, ethylene/propylene copolymers, and polymethylpentene copolymers. Of these, polypropylene is preferred from the standpoints of production cost and thermal properties. From the standpoints of production cost, spinnability, and stretchability, polyethylene is preferred. Furthermore, from the standpoint of spinnability, the polypropylene to be used in the invention preferably has a value of Q (weight-average molecular weight/number-average molecular weight) of 2 to 5, and the polyethylene used in the invention preferably has a value of Q of 3 to 6. The MFR of such a polyolefin resin suitable for use is not particularly limited as long as spinning is possible. However, the MFR thereof is preferably 1 to 100 g/10 min, more preferably 5 to 70 g/10 min, from the standpoint of spinnability. Polyolefins having an MFR of 1 g/10 min or higher are preferred from the standpoints of spinnability and stretchability because of the reduction of melt tension. The values of MFR of not higher than 100 g/10 min are more preferred because such polyolefin ingredients have improved peel property and the fiber obtained can be split into microfibers to a desired level by physical stress, and because spinnability can be simultaneously maintained to attain high productivity. From the standpoint of spinnability, a melting point of such polypropylene is preferably 100 to 190° C., more preferably 120 to 170° C., and a melting point of such polyethylene is preferably 80 to 170° C., especially preferably 90 to 140° C.

In producing the polyacetal and polyolefin, other ingredient may be copolymerized for the purpose of modification, e.g., for improving splittability or chemical resistance. Furthermore, various other kinds of polymers may be mixed, or various kinds of additives may be incorporated thereinto. For example, an inorganic pigment such as carbon black, chrome yellow, cadmium yellow, or iron oxide, or an organic pigment such as a disazo pigment, anthracene pigment, or phthalocyanine pigment can be incorporated for the purpose of coloring.

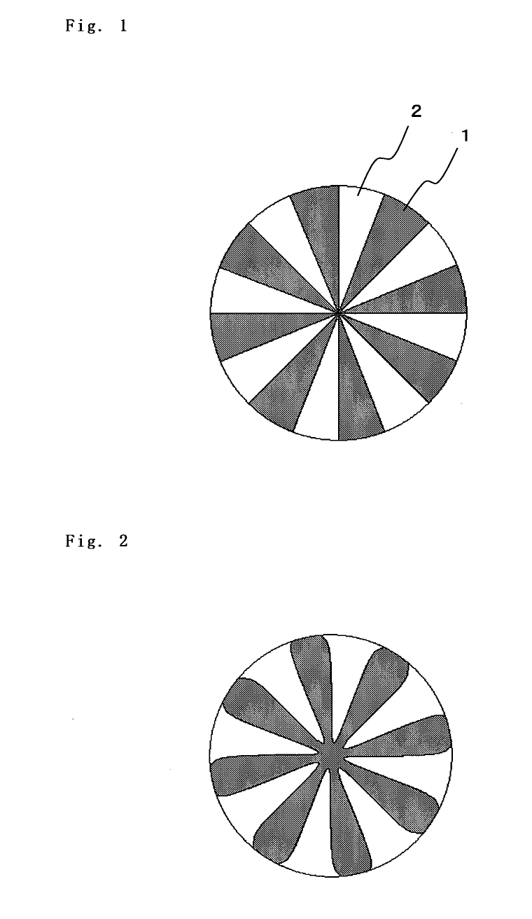

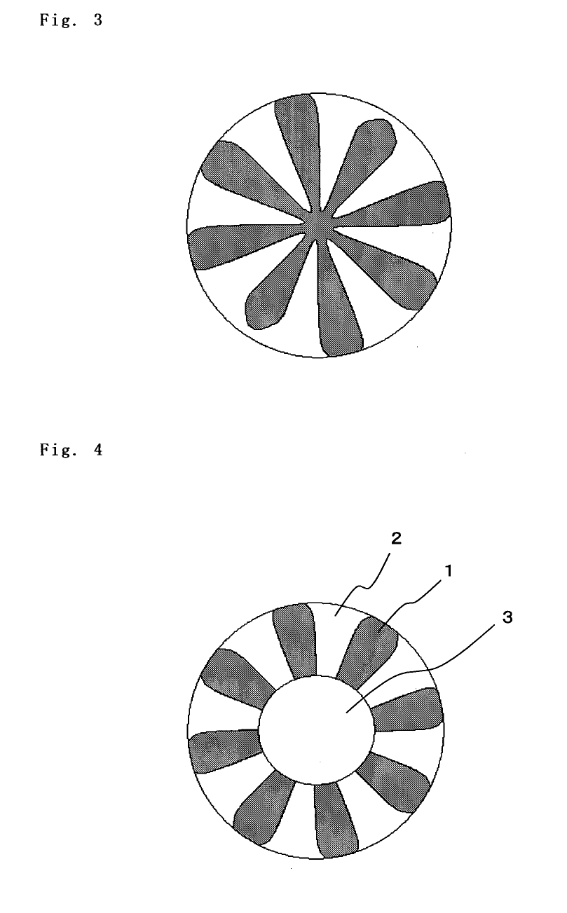

Sections of the splittable conjugate fiber of the invention will be explained next. FIGS. 1 to 6 are sectional views showing examples of splittable conjugate fibers usable in the invention. From the standpoint of reducing the area in which one component is in contact with the adjoining component to thereby improve splittability, it is preferred that the fiber section in a direction perpendicular to the length direction for the splittable conjugate fiber should be one in which the polyacetal and the polyolefin are alternately arranged in the peripheral direction. With respect to the degree of exposure of the polyacetal in the fiber surface, it is preferred that the polyacetal should account for 10 to 90% of the periphery of the fiber section perpendicular to the fiber axis. When the polyacetal accounts for 10 to 90% of the periphery of the fiber section, resin interfaces where splitting begins to occur are exposed in the fiber surface, whereby this fiber shows the excellent splittability which is characteristic of the invention. End parts of the resin interfaces of one component (1) may be at least partly covered with the other component (2) (FIG. 3). Fibers having such a section may constitute at least a part of all fibers. From the standpoint of splittability under the condition that each component should account for at least 10% of the periphery of the fiber section, with respect to end parts of the resin interfaces extending toward the surface of each fiber and with respect to average value for end parts of the resin interfaces extending toward the fiber surfaces of arbitrarily selected ten fibers, it is desirable that the ratio (r/d) of the distance (r) between the fiber center and the end part of each resin interface extending toward the fiber surface to the distance (d) between the fiber center and the fiber surface should be 0.7 to 1.0, especially in the range of 0.8 to 1.0. Such sectional shape and the mixed proportions of fibers having the sectional shape differing in the r/d ratio may be regulated by changing the shape of the nozzle and the MFRs of the resin ingredients constituting the fibers. Specifically, fibers having a shape in which the polyacetal is exposed in the periphery of the fiber section in a relatively large proportion can be produced, for example, by placing a polyacetal resin passageway inside a nozzle disposed near the periphery of the nozzle orifice, by employing a combination in which the polyolefin has a relatively lower MFR than the polyacetal, by setting a relatively high spinning temperature for the polyacetal, or the like. The ratio of the MFR of the polyolefin used in the splittable conjugate fiber of the invention to that of the polyacetal is preferably 0.2 to 5.0, especially 0.2 to 0.8. When the ratio of the MFR of the polyolefin used in the splittable conjugate fiber of the invention to that of the polyacetal is 0.8 to 1.25, a fiber having a sectional shape such as that shown in FIG. 1 can be advantageously obtained. When the ratio is lower than 0.8, then a fiber having a sectional shape in which the polyacetal is exposed in the periphery of the fiber section in a relatively large proportion, such as the sectional shape shown in FIG. 2 or 3 in which the white segments are the polyacetal, can be advantageously obtained. When the ratio is higher than 1.25, then a fiber having a sectional shape in which the polyolefin is exposed in the periphery of the fiber section in a relatively large proportion, such as the sectional shape shown in FIG. 2 or 3 in which the white segments are the polyolefin, can be advantageously obtained. From the standpoint of efficiently producing a fiber in which the polyacetal is exposed in the periphery of the fiber section in a large proportion, it is preferred that spinning is performed at 190° C. or higher. The components are connected and united with each other on the fiber center side, and are present independently of each other. The number of resin interface end parts of each component which extend toward the fiber surface may be 2 or larger. However, that number for each component is preferably 4 to 18, more preferably 5 to 12, from the standpoints of spinnability and of obtaining finer microfibers through splitting. When the number of resin interface end parts of each component which extend toward the fiber surface is 4 or larger, it is preferred from the standpoint that finer micro fibers are obtained through splitting. Regulating the number thereof to 18 or smaller is preferred from the standpoint that resin flowability in the spinning nozzle is optimized to attain stable spinning. The periphery of the fiber may be a true circle or may have an elliptic shape or another sectional shape such as a polygon, e.g., triangle to octagon, such shapes do not pose any problem at all.

It is preferred that the splittable conjugate fiber of the invention should have a hollow especially preferably in a central part of the fiber. FIGS. 4, 5, and 6 show sectional views illustrating embodiments of the splittable conjugate fiber having a hollow. The shape of the hollow may be any of circular, elliptic, triangular, quadrangular, and other shapes. The proportion of the hollow is desirably in the range of 1 to 50%, especially 5 to 40%, in terms of the areal proportion thereof in the fiber section perpendicular to the fiber axis. When the proportion thereof is 1% or higher, contact between adjoining resin components on the fiber center side and the area of the contact are reduced and this enables the unsplit fiber to be readily crushed when split into finer fibers by physical stress. In this case, low energy suffices to separate the two components at the contact interface between these. Namely, the presence of a hollow is apt to produce the effect of improving splittability. The proportions of the hollow of 40% or lower are more preferred because spinnability is maintained and high productivity can be realized while maintaining reduced contact and a reduced area of contact between adjoining resin components and maintaining a desired level of splitting into finer fibers by physical stress. Besides being formed the hollow in a central part of the fiber, the hollow may be formed in the following manner. A blowing agent is incorporated into either of a polyacetal and a polyolefin, and these polymers are spun. As a result, a hollow can be formed in either of the polyacetal and the polyolefin by the action of the blowing agent. This hollow is present at the interface between the polyacetal and polyolefin components to reduce the area of contact between the adjoining components. Consequently, low impact energy suffices to split the fiber, and the property of being readily split can be greatly improved. Examples of the blowing agent include azodicarbonamide, barium azodicarboxylates, N,N-dinitrosopentamethylenetetramine, p-toluenesulfonylsemicarbazide, and trihydrazinotriazine.

The splittable conjugate fiber of the invention preferably has a single-yarn fineness of 1 to 15 dtex (decitexes). The single-yarn fineness is determined by controlling the amount of the resins being discharged from the single orifice of a spinning nozzle. When the discharge amount of the resin is regulated so as to result in a single-yarn fineness of 1 dtex or larger, the target sectional state is apt to be obtained. In addition, the amount of the resins being discharged from the single orifice of the spinning nozzle during melt spinning is stable and, hence, spinnability and stretchability are kept satisfactory.

Furthermore, by regulating the discharge amount of the resin so as to result in a single-yarn fineness of 15 dtex or smaller, the filament can be sufficiently cooled. As a result, draw resonance, which is attributable to insufficient cooling, does not occur and sufficiently stable spinnability/stretchability can be maintained. The average single-yarn fineness after splitting is preferably smaller than 0.6 dtex, more preferably 0.5 dtex or smaller, from the standpoint of obtaining through splitting fibers a flexible fibrous form which is even and has a satisfactory texture, which is the greatest characteristic in the conjugate fibers.

A process for producing a splittable conjugate fiber comprising a combination of a polyacetal resin and a polypropylene resin, as one embodiment of the splittable conjugate fiber of the invention, is shown below as an example. In producing this splittable conjugate fiber, the known melt conjugate spinning process is used to spin the resins. The resultant filament is cooled with blowing air by means of a known cooler such as lateral blowing or circular blowing. Thereafter, a surfactant is applied to the cooled filament to obtain an unstretched yarn through a draw-off roller.

A spinning nozzle for known splittable conjugate fibers may be used. A spinning temperature is especially important from the standpoint of optimizing spinnability and fiber sectional shape. Specifically, the spinning of the polyacetal resin is conducted preferably in the range of 170 to 250° C., especially preferably 190 to 250° C. With respect to the polyacetal resin, spinning at 250° C. or lower is preferred from the standpoint of inhibiting pyrolysis, and spinning at 190° C. or higher is preferred from the standpoint of securing spinnability. The spinning of the polypropylene resin is conducted preferably in the range of 190 to 330° C., especially preferably 210 to 260° C., from the standpoint of securing spinnability. A speed of the draw-off roller is preferably 500 to 2,000 m/min. Two or more such unstretched yarns thus obtained are bundled and subjected to stretching with a known stretching machine between rollers differing in peripheral speed. Multistage stretching may be conducted according to need. The stretch ratio may be in the range of generally about from 2 to 5. Subsequently, the stretched tow (fiber bundle) was crimped with a push-in type crimper according to need and then cut into a given fiber length to obtain short fibers. The process steps shown above are ones for producing short fibers. However, without being cut, the long-fiber tow may be treated with, e.g., a yarn-dividing guide to obtain a web. Thereafter, the fibers are subjected to higher-order processing steps according to need and then formed into a fibrous form according to any of various applications. It is also possible to use a method in which the filament obtained through spinning and stretching is rolled up as a filament yarn and this yarn is knitted or woven to obtain a fibrous form as a knitted or woven article. Alternatively, use may be made of a method in which the short fibers are formed into a spun yarn and this yarn is knitted or woven to obtain a fibrous form as a knitted or woven article.

Namely, the term of fibrous form herein means any product constituted of fibers gathered together. Examples thereof include woven fabrics, knitted fabrics, continuous fiber bundles, nonwoven fabrics, and nonwoven fiber aggregates. Furthermore, the fibers may be formed into a fabric by a technique such as fiber blending, mix spinning, filament combination, co-twisting, union knitting, union weaving, or the like. Examples of the nonwoven fiber aggregates include web-form even products obtained by a carding process, an air laying process, a papermaking process or the like, and multilayered products obtained by laminating one or more of woven fabrics, knitted fabrics, and nonwoven fabrics to such a web-form product. Examples thereof further include slivers.

The fibrous form of the invention may be a mixture of the splittable conjugate fiber of the invention and other fibers and powders according to need, as long as this does not lessen the effects of the invention. Examples of such optional fibers include synthetic fibers such as polyamide, polyester, polyolefin, and acrylic, fibers obtained by imparting a function such as, e.g., biodegradability or deodorizing properties to such synthetic fibers, natural fibers such as cotton, wool, and hemp, regenerated fibers such as rayon, cupra, and acetate, and semisynthetic fibers. Examples of the powders include natural-derived substances, such as pulverized pulp, leather powder, bamboo charcoal powder, wood charcoal powder, and agar powder, synthetic polymers such as water-absorbing polymers, and inorganic substances such as iron powder and titanium oxide.

After the splittable conjugate fiber of the invention is obtained through spinning in the manner described above, a surfactant may be adhered thereto for the purpose of e.g., static protection of the fiber or imparting surface smoothness for improving processing property. The kind and concentration of the surfactant may be suitably regulated according to applications. For the adhesion method, use may be made of a roller method, immersion method, padding-and-drying method, or the like. The adhesion is not limited in the spinning step described above, and the adhesion may be performed in either of the stretching step or the crimping step. Furthermore, regardless of whether the fiber is a short fiber or a long fiber, a surfactant may be adhered thereto in a stage other than the spinning step, stretching step, and crimping step, such as, e.g., after the formation of a fibrous form.

The fiber length of the splittable conjugate fiber of the invention is not particularly limited. However, in the case of producing a web using a carding machine, fibers of 20 to 76 mm are generally used. In the case of the papermaking process or airlaying process, it is generally preferred to use fibers of 20 mm or shorter. When fibers having a length regulated to 76 mm or shorter are used, a web formation with a carding machine or the like can be evenly conducted and a web having an even texture can be easily obtained.

The splittable conjugate fiber of the invention is applicable to various processes for fibrous-form production including the airlaying process. Processes for producing a nonwoven fabric are shown as examples. For example, the short fibers obtained from the splittable conjugate fiber described above are used to produce a web having a necessary basis weight by the carding, airlaying, or papermaking process. Alternatively, a web may be directly produced by a melt-blowing process, spun-bonding process, or the like. The web produced by the above method can be subjected to fiber splitting into microfibers by a known method such as, e.g., the needle punching method or high-pressure liquid jet treatment, whereby a fibrous form can be obtained. It is also possible to treat this fibrous form by a known processing technique with hot air or a heated roll.

Methods for splitting the splittable conjugate fiber of the invention are not particularly limited. Examples thereof include methods such as a needle punching method and high-pressure liquid jet treatment. The method of splitting by the high-pressure liquid jet treatment is explained here as an example. As an apparatus for the high-pressure liquid jet treatment, use may be made of an apparatus having many ejection holes with a diameter of, e.g., 0.05 to 1.5 mm, especially 0.1 to 0.5 mm, arranged at an interval of 0.1 to 1.5 mm in one or more rows. High-pressure liquid jets obtained by ejecting a liquid from the ejection holes at a high water pressure are caused to collide against the web or nonwoven fabric placed on a porous supporting member. Thus, the unsplit splittable conjugate fiber of the invention is entangled and simultaneously split into finer fibers by the high-pressure liquid jets. The rows of the ejection holes are arranged in a raw in perpendicular to the web travel direction. As the high-pressure liquid jets, use may be made of ordinary-temperature one or warm water or any other desired liquid. The distance between the array of ejection holes and the web or nonwoven fabric is preferably 10 to 150 mm. When that distance is smaller than 10 mm, there are cases where this treatment yields a fibrous form having a disordered texture. On the other hand, when that distance exceeds 150 mm, there are cases where the physical impact of the liquid jets on the web or nonwoven fabric is weak and the entanglement and fiber splitting into finer fibers are not sufficiently undergo. Pressure in this high-pressure liquid jet treatment is regulated according to the production process and the performances required of the fibrous form. However, it is generally preferred to eject high-pressure liquid jets at a pressure of 20 to 200 kg/cm². A method may be used in which the web or nonwoven fabric is treated in such a manner that the pressure of the high-pressure liquid jets increases successively from a low water pressure to a high water pressure within the above treatment pressure range, although that range depends on the basis weight being treated, etc. This method is less apt to disorder the texture of the web or nonwoven fabric and can attain entanglement and splitting into finer fibers. The porous supporting member on which the web or nonwoven fabric is placed in the treatment with high-pressure liquid jets is not particularly limited as long as it enables the high-pressure liquid jets to pass through the web or nonwoven fabric. For example, a metallic or synthetic-resin mesh screen of 50 to 200 mesh or a perforated plate may be used. Incidentally, use may be made of a method which comprises subjecting the web or nonwoven fabric to a high-pressure liquid jet treatment from one side, subsequently reversing the entangled web or nonwoven fabric, and subjecting it to the high-pressure liquid jet treatment. This method can yield a fibrous form in which both the front and back sides are dense and have a satisfactory texture. After the high-pressure liquid jet treatment, water is removed from the fibrous form which is obtained after treatment. For this water removal, known methods can be employed. For example, a squeezer such as a mangle is used to remove water in some degree and a drying apparatus such as a circulating hot-air drying apparatus is then used to completely remove water, whereby a fibrous form of the invention can be obtained.

The basis weight of the fibrous form of the invention is not particularly limited. However, the fibrous form having a basis weight of 10 to 200 g/m² can be suitably used. When the fibrous form has a basis weight of 10 g/m² or higher, the texture of the woven fabric can be kept satisfactory when the splittable conjugate fiber is split into finer fibers by physical stress obtained by, e.g., a high-pressure liquid jet treatment. When the fibrous form has a basis weight of 200 g/m² or lower, even splitting can be conducted with a satisfactory texture without excessively conducting the high-pressure liquid jet treatment.

Compared to conventional polyolefin-based splittable fibers, the splittable conjugate fiber of the invention can be easily split. Even the physical impact obtained by the high-pressure liquid jets is low, the conjugate fiber of the invention can be split into finer fibers. When the splittable conjugate fiber of the invention is used, a fibrous form can be easily obtained in which 50% or more of the conjugate fiber is split. In particular, a fibrous form in which 60% or more, especially 70% or more, of the conjugate fiber is split can be easily obtained. Because of this, an increase in the rate of a high-pressure liquid jet treatment, which is a rate-determining step in spun-lace, and a texture improvement by reducing the pressure of high-pressure liquid jets can be attained. In the case of a web comprising short fibers, such as, e.g., one produced by the papermaking process, the pressure of high-pressure liquid jets can be reduced, whereby problems such as a texture disorder in the fibrous form and through-hole formation can be mitigated.

Furthermore, the splittable conjugate fiber of the invention has excellent resistance to chemicals, especially to alkalis, because it is a splittable conjugate fiber comprising a polyacetal and a polyolefin which each have excellent chemical resistance.

As described above, the splittable conjugate fiber of the invention can be easily split and a dense fibrous form having a satisfactory texture can be obtained therefrom. The conjugate fiber further has excellent chemical resistance. Nonwoven fabrics which are highly dense and have a satisfactory texture can be obtained from the splittable conjugate fiber of the invention. Products of such nonwoven fabrics not only are suitable for use in the field of hygienic materials such as diapers and napkins, but also are suitable for use in the field of industrial materials such as battery separators, wipers, and filters.

The splittable conjugate fiber of the invention may be used as a fibrous aggregates containing the conjugate fiber in an amount of 10% by weight or larger. Other fibers which can be used in combination with the splittable conjugate fiber of the invention are not particularly limited. Examples thereof include splittable conjugate fibers outside the scope of the invention, heat-bondable conjugate fibers based on polypropylene and high-density polyethylene, heat-bondable conjugate fibers based on polypropylene and an ethylene-copolymerized polypropylene, heat-bondable conjugate fibers based on polypropylene and a ethylene-butene-1 copolymerized polypropylene, heat-bondable composite fibers based on a polyester and high-density polyethylene, polyester fibers, polyolefin fibers, and rayon.

### EXAMPLES

The invention will be explained below in detail by reference to Examples. However, the invention should not be limited thereto. Methods used for determining property values shown in the Examples or the definitions of the properties are shown below.

### (1) Single-Yarn Fineness

Measurement was made in accordance with JIS-L-1015.

### (2) Tensile Strength and Elongation

Measurement was made with Autograph AGS 500D, manufactured by Shimadzu Corp., in accordance with JIS-L-1017 under the conditions of a sample length of 100 mm and a tensile rate of 100 mm/min.

### (3) Melt Flow Rate (MFR)

Measurement was made in accordance with JIS-K-7210.

Raw-material polyacetal resin: conditions 4

Raw-material polypropylene resin: conditions 14

Raw-material polyethylene resin: conditions 4

Raw-material polymethylpentene resin: conditions

(4) Method of Determining (r/d)

The following values were calculated from cross-sectional photographs of arbitrarily selected ten unsplit fibers. The value of r/d was calculated from the averages of those.

r: Average distance between peripheral end of covered component and fiber center

d: Average distance between fiber center and fiber surface

### (5) Method of Determining Proportion of Hollow

The proportion of hollow was calculated from ten unsplit fibers arbitrarily selected on a photograph of cross-sections of unsplit fibers by using the following equation.

Proportion of hollow(%)=[(sectional area of the hollow)/(total sectional area of the fiber including the hollow)]×100

### (6) Method of Determining Degree of Polyacetal Exposure in Fiber Surface

The following values were calculated from ten unsplit fibers arbitrarily selected on a photograph of cross-sections of unsplit fibers. The degree of polyacetal exposure in the fiber surface was calculated from the averages of those.

c: Length of periphery of fiber section perpendicular to fiber axis

w: Length of arcs constituted of polyacetal in periphery of fiber section perpendicular to fiber axis

Degree of polyacetal exposure in fiber surface (%)=(w/c)×100

### (7) Spinnability

Stringiness when melt spinning was evaluated in the following three grades in terms of the number of filament breaks which occurred.

A: No filament break occurs and operation is satisfactory.

B: One or two filament breaks occur per hour.

C: Four or more filament breaks occur per hour and this is problematic in operation.

### (8) Stretch Ratio

Stretch ratio was calculated using the following equation.

Stretch ratio=[draw-off roll speed(m/min)]/[feed roll speed(m/min)]

### (9) Evaluation of Splittability

Splittability was evaluated through a splitting operation with a mixer (Osterizer Blender) as a substitute evaluation for a high-pressure liquid jet treatment. A water stream in the mixer gives the same physical stimulus to fibers as being given by the high-pressure liquid jet treatment, to thereby split the fibers.

### (Method of Producing Split-Fiber Web)

Into the mixer were introduced 500 mL of deionized water and 1.0 g (fiber weight) of a splittable conjugate fiber of the invention. The contents were stirred at 7,900 rpm for 3 minutes. The resultant mixture was filtered through a Buchner funnel having a diameter of 12 cm, and dried at 80° C.

### (Method of Measuring Air Permeability)

The split-fiber web was sandwiched between 150-mesh metallic gauzes, and an air permeability was measured in accordance with JIS L 1096 method 6.27 A.

The higher the splittability is, the denser the web is. In the case of fibers which have the same fiber diameter before splitting, an index to splittability is obtained by comparing the air permeability of split-fiber webs. Namely, with respect to fibers which have the same fiber diameter before splitting, the following judgment can be formed. The lower the air permeability of the split-fiber web is, the higher the splittability of the splittable conjugate fiber is and the easier the splitting of this fiber is.

### (10) Texture

Ten panelists examined a nonwoven fabric (1 m square) which had undergone fiber splitting into finer fibers. The fabric was visually examined for fiber distribution unevenness, and the results were judged based on the following criteria.

A: At least seven panelists felt that the fabric had little unevenness and no through-holes.

B: Four to six panelists felt that the fabric had little unevenness and no through-holes.

C: The number of panelists who felt that the fabric had little unevenness was 3 or smaller.

### (11) Chemical Resistance

A fiber was immersed in 100 mL of ethanol or an aqueous sodium hydroxide solution and allowed to stand in this state at 20° C. for 3 months. The fiber was examined for the amount of weight change through the standing. The results were judged based on the following criteria.

A: A decrease of the fiber weight is less than 0.3%.

B: A decrease of the fiber weight is 0.3% or more and less than 2.0%.

C: A decrease of the fiber weight is 2.0% or more.

### (12) Measurement of Tc and Qc at Various V Values

Differential scanning calorimeter DSC Q10 (trade name), manufactured by TA Instruments. Inc., was used to measure a crystallization temperature Tc (° C.) when cooling a polyacetal resin melted at 210° C. at various rates. Specifically, 4.0 to 4.5 mg of a polyacetal resin sample was heated from room temperature to 210° C. at a heating rate of 10° C./min, held at this temperature for 10 minutes, and then cooled at a rate of 5, 10, 20, 30, or 65° C./min. The crystallization temperature Tc (° C.) was determined from the resultant heat flux peak. Furthermore, the amount of heat of crystallization Qc at a logV of 1 was determined from a value obtained by integrating the heat flux based on a base line drawn at 130 to 150° C.

### Example 1

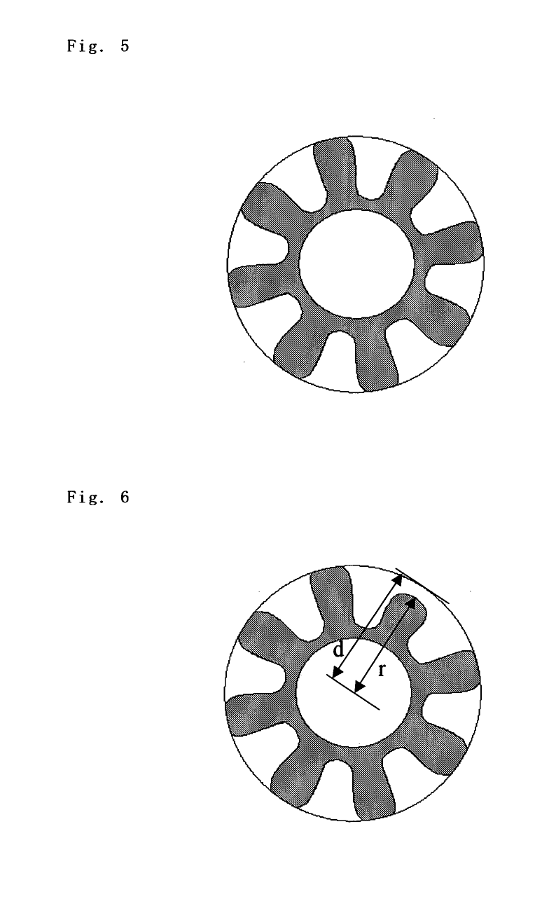

As a polyacetal was used a polyacetal copolymer which had a melting point of 160° C. and an MFR of 9 and in which the graph obtained by plotting Tc against logV had an inclination A of −9.0 and the Tc as measured at a logV of 1 (Tc′) and the Qc were 141° C. and 106 J/g, respectively. As a polyolefin was used polypropylene having a melting point of 160° C., MFR of 16, and Q value of 4.9. A nozzle for splittable conjugate fibers was used to spin these polymers and obtain hollow splittable conjugate fibers which had a polyacetal/polyolefin proportion of 50/50 by volume and a fineness of 8.9 dtex and which mainly had a cross-sectional shape such as that shown in FIG. 5, and further partly had cross-sectional shapes such as those shown in FIGS. 4 and 6. In these fibers, the number of resin interface end parts extending toward the fiber surface was 8 with respect to each component. Namely, these fibers were split into 16. The fibers included a fiber having a structure in which part of the resin interface end parts of the polyacetal copolymer were covered with the polypropylene. The value of r/d concerning the polyacetal copolymer was 0.97. The fibers had a proportion of hollow of 20.3%. The degree of polyacetal exposure in the fiber surface was 28.9%.

An alkyl phosphate potassium salt was adhered to the fibers in a draw-off step. The unstretched yarn obtained was stretched at 80° C. in a ratio of 4.7, and a dispersant for papermaking was adhered thereto. The yarn was then cut into a length of 6 mm.

The short fibers obtained were subjected to the splitting treatment with a mixer described above to obtain a fibrous form of the invention. The fiber properties obtained and the air permeability and other properties of the fibrous form are shown in Table 1.

### Example 2

As a polyacetal was used a polyacetal copolymer which had a melting point of 160° C. and an MFR of 31 and in which the graph obtained by plotting Tc against logV had an inclination A of −9.4 and the Tc as measured at a logV of 1 (Tc′) and the Qc were 141° C. and 119 J/g, respectively. As a polyolefin was used polypropylene having a melting point of 160° C., MFR of 16, and Q value of 4.9. A nozzle for splittable conjugate fibers was used to spin these polymers and obtain hollow splittable conjugate fibers which had a polyacetal/polyolefin proportion of 50/50 by volume and a fineness of 8.9 dtex and which mainly had a cross-sectional shape such as that shown in FIG. 4, and further partly had a cross-sectional shape such as that shown in FIG. 5. In these fibers, the number of resin interface end parts extending toward the fiber surface was 8 with respect to each component. Namely, these fibers were split into 16. The value of r/d concerning the polyacetal copolymer was 1.00. The fibers had a proportion of hollow of 9.2%. The degree of polyacetal exposure in the fiber surface was 60.2%.

An alkyl phosphate potassium salt was adhered to the fibers in a draw-off step. The unstretched yarn obtained was stretched at 80° C. in a ratio of 4.7, and a dispersant for papermaking was adhered thereto. The yarn was then cut into a length of 6 mm.

The short fibers obtained were subjected to the same splitting treatment as in Example 1 to obtain a fibrous form of the invention. The fiber properties obtained and the air permeability and other properties of the fibrous form are shown in Table 1.

### Example 3

As a polyacetal was used a polyacetal copolymer which had a melting point of 160° C. and an MFR of 9 and in which the graph obtained by plotting Tc against logV had an inclination A of −9.0 and the Tc as measured at a logV of 1 (Tc′) and the Qc were 141° C. and 106 J/g, respectively. As a polyolefin was used polypropylene having a melting point of 160° C., MFR of 11, and Q value of 4.9. A nozzle for splittable conjugate fibers was used to spin these polymers and obtain hollow splittable conjugate fibers which had a polyacetal/polyolefin proportion of 50/50 by volume and a fineness of 8.9 dtex and which mainly had a cross-sectional shape such as that shown in FIG. 5, and further partly had cross-sectional shapes such as those shown in FIGS. 4 and 6. In these fibers, the number of resin interface end parts extending toward the fiber surface was 8 with respect to each component. Namely, these fibers were split into 16. The fibers included a fiber having a structure in which part of the resin interface end parts of the polyacetal copolymer were covered with the polypropylene. The value of r/d concerning the polyacetal copolymer was 0.97. The fibers had a proportion of hollow of 24.7%. The degree of polyacetal exposure in the fiber surface was 28.9%.

An alkyl phosphate potassium salt was adhered to the fibers in a draw-off step. The unstretched yarn obtained was stretched at 80° C. in a ratio of 4.7, and a dispersant for papermaking was adhered thereto. The yarn was then cut into a length of 6 mm.

The short fibers obtained were subjected to the same splitting treatment as in Example 1 to obtain a fibrous form of the invention. The fiber properties obtained and the air permeability and other properties of the fibrous form are shown in Table 1.

### Example 4

As a polyacetal was used a polyacetal copolymer which had a melting point of 160° C. and an MFR of 9 and in which the graph obtained by plotting Tc against logV had an inclination A of −9.0 and the Tc as measured at a logV of 1 (Tc′) and the Qc were 141° C. and 106 J/g, respectively. As a polyolefin was used polypropylene having a melting point of 160° C., MFR of 30, and Q value of 2.9. A nozzle for splittable conjugate fibers was used to spin these polymers and obtain hollow splittable conjugate fibers which had a polyacetal/polyolefin proportion of 50/50 by volume and a fineness of 8.9 dtex and which mainly had a cross-sectional shape such as that shown in FIG. 5, and further partly had cross-sectional shapes such as those shown in FIGS. 4 and 6. In these fibers, the number of resin interface end parts extending toward the fiber surface was 8 with respect to each component. Namely, these fibers were split into 16. The fibers included a fiber having a structure in which part of the resin interface end parts of the polyacetal copolymer were covered with the polypropylene. The value of r/d concerning the polyacetal copolymer was 0.97. The fibers had a proportion of hollow of 16.9%. The degree of polyacetal exposure in the fiber surface was 25.1%.

An alkyl phosphate potassium salt was adhered to the fibers in a draw-off step. The unstretched yarn obtained was stretched at 80° C. in a ratio of 4.7, and a dispersant for papermaking was adhered thereto. The yarn was then cut into a length of 6 mm.

The short fibers obtained were subjected to the same splitting treatment as in Example 1 to obtain a fibrous form of the invention. The fiber properties obtained and the air permeability and other properties of the fibrous form are shown in Table 1.

### Example 5

As a polyacetal was used a polyacetal copolymer which had a melting point of 160° C. and an MFR of 9 and in which the graph obtained by plotting Tc against logV had an inclination A of −9.0 and the Tc as measured at a logV of 1 (Tc′) and the Qc were 141° C. and 106 J/g, respectively. As a polyolefin was used high-density polyethylene having a melting point of 130° C., MFR of 16.5, and Q value of 5.1. A nozzle for splittable conjugate fibers was used to spin these polymers and obtain hollow splittable conjugate fibers which had a polyacetal/polyolefin proportion of 50/50 by volume and a fineness of 8.9 dtex and which mainly had a cross-sectional shape such as that shown in FIG. 5, and further partly had cross-sectional shapes such as those shown in FIGS. 4 and 6. In these fibers, the number of resin interface end parts extending toward the fiber surface was 8 with respect to each component. Namely, these fibers were split into 16. The fibers included a fiber having a structure in which part of the resin interface end parts of the polyacetal copolymer were covered with the high-density polyethylene. The value of r/d concerning the polyacetal copolymer was 0.97. The fibers had a proportion of hollow of 14.3%. The degree of polyacetal exposure in the fiber surface was 25.8%.

An alkyl phosphate potassium salt was adhered to the fibers in a draw-off step. The unstretched yarn obtained was stretched at 80° C. in a ratio of 4.7, and a dispersant for papermaking was adhered thereto. The yarn was then cut into a length of 6 mm.

The short fibers obtained were subjected to the same splitting treatment as in Example 1 to obtain a fibrous form of the invention. The fiber properties obtained and the air permeability and other properties of the fibrous form are shown in Table 1.

### Comparative Example 1

Polypropylene having a melting point of 160° C. and high-density polyethylene having a melting point of 130° C. were used. A nozzle for splittable conjugate fibers was used to spin these polymers and obtain hollow splittable conjugate fibers which had a polypropylene/polyethylene proportion of 50/50 by volume and a fineness of 6.5 dtex and which had a cross-sectional shape such as that shown in FIG. 4. The polypropylene had an MFR of 11 and a Q value of 4.9, while the high-density polyethylene had an MFR of 16.5 and a Q value of 5.1. In the fibers, the number of resin interface end parts extending toward the fiber surface was 8 with respect to each component. Namely, these fibers were split into 16. The value of r/d concerning the polypropylene was 1.00. The fibers had a proportion of hollow of 18.7%. The degree of polypropylene exposure in the fiber surface was 26.8%.

An alkyl phosphate potassium salt was adhered to the fibers in a draw-off step. The unstretched yarn obtained was stretched at 95° C. in a ratio of 4.4, and a dispersant for papermaking was adhered thereto. The yarn was then cut into a length of 5 mm. The splittable conjugate fibers thus obtained had the same fiber diameter as in Examples 1 to 5.

The short fibers obtained were subjected to the splitting treatment with a mixer to obtain a fibrous form. The fiber properties obtained and the air permeability and other properties of the fibrous form are shown in Table 1.

### Comparative Example 2

Polyethylene terephthalate having a melting point of 260° C. and polypropylene having a melting point of 160° C. were used. A nozzle for splittable conjugate fibers was used to spin these polymers and obtain hollow splittable conjugate fibers which had a polyethylene terephthalate/polypropylene proportion of 50/50 by volume and a fineness of 5.4 dtex and which mainly had a cross-sectional shape such as that shown in FIG. 5, and further had cross-sectional shapes such as those shown in FIGS. 4 and 6. The polyethylene terephthalate had an intrinsic viscosity of 0.64, while the polypropylene had an MFR of 30 and a Q value of 2.9. In these fibers, the number of resin interface end parts extending toward the fiber surface was 8 with respect to each component. Namely, these fibers were split into 16. The fibers included a fiber having a structure in which part of the resin interface end parts of the polyethylene terephthalate were covered with the polypropylene. The value of r/d concerning the polyethylene terephthalate was 0.97. The fibers had a proportion of hollow of 14.5%. The degree of polyethylene terephthalate exposure in the fiber surface was 35.0%.

An alkyl phosphate potassium salt was adhered to the fibers in a draw-off step. The unstretched yarn obtained was stretched at 90° C. in a ratio of 1.8, and a dispersant for papermaking was adhered thereto. The yarn was then cut into a length of 6 mm.

The short fibers obtained were subjected to the same splitting treatment as in Example 1 to obtain a fibrous form. The fiber properties obtained and the air permeability and other properties of the fibrous form are shown in Table 1.

### Comparative Example 3

As a polyacetal was used a polyacetal copolymer which had a melting point of 160° C. and an MFR of 9 and in which the graph obtained by plotting Tc against logV had an inclination A of −10.1 and the Tc as measured at a logV of 1 (Tc′) and the Qc were 145° C. and 148 J/g, respectively. As a polyolefin was used polypropylene having a melting point of 160° C., MFR of 11, and Q value of 4.9. A nozzle for splittable conjugate fibers was used to spin these polymers and obtain hollow splittable conjugate fibers which had a polyacetal/polyolefin proportion of 50/50 by volume and a fineness of 8.3 dtex and which mainly had a cross-sectional shape such as that shown in FIG. 5, and further partly had cross-sectional shapes such as those shown in FIGS. 4 and 6. These fibers had poor spinnability, and a sample sufficient for examining various fiber properties could not be obtained.

### Comparative Example 4

As a polyacetal was used a polyacetal copolymer which had a melting point of 160° C. and an MFR of 9 and in which the graph obtained by plotting Tc against logV had an inclination A of −10.1 and the Tc as measured at a logV of 1 (Tc′) and the Qc were 145° C. and 148 J/g, respectively. As a polyolefin was used polymethylpentene having a melting point of 238° C. and an MFR of 85. A nozzle for splittable conjugate fibers was used to spin these polymers and obtain hollow splittable conjugate fibers which had a polyacetal/polyolefin proportion of 50/50 by volume and a fineness of 9.1 dtex and which mainly had a cross-sectional shape such as that shown in FIG. 5, and further partly had cross-sectional shapes such as those shown in FIGS. 4 and 6. These fibers had poor spinnability, and a sample sufficient for examining various fiber properties could not be obtained.

### Comparative Example 5

As a polyacetal was used a polyacetal copolymer which had a melting point of 160° C. and an MFR of 9 and in which the graph obtained by plotting Tc against logV had an inclination A of −10.1 and the Tc as measured at a logV of 1 (Tc′) and the Qc were 145° C. and 148 J/g, respectively. As a polyolefin was used polymethylpentene having a melting point of 238° C. and an MFR of 85. A nozzle for splittable conjugate fibers was used to spin these polymers and obtain solid splittable conjugate fibers which had a polyacetal/polyolefin proportion of 50/50 by volume and a fineness of 9.1 dtex. In these fibers, the number of resin interface end parts extending toward the fiber surface was 4 with respect to each component. Namely, these fibers were split into 8. The fibers included a fiber having a structure in which part of the resin interface end parts of the polyacetal copolymer were covered with the polymethylpentene. The value of r/d concerning the polyacetal copolymer was 0.97. The degree of polyacetal exposure in the fiber surface was 27.3%.

An alkyl phosphate potassium salt was adhered to the fibers in a draw-off step. The unstretched yarn obtained was stretched at 90° C. in a ratio of 4.0, and a dispersant for papermaking was adhered thereto. The yarn was then cut into a length of 6 mm.

The short fibers obtained were subjected to the same splitting treatment as in Example 1 to obtain a fibrous form. The fiber properties obtained and the air permeability and other properties of the fibrous form are shown in Table 1.

Those fibers had poor spinnability, and the sample obtained had many yarn ends attributable to yarn breakage. Because of this, the texture of the fibrous form was not satisfactory.

TABLE 1

| | | Example 1 | Example 2 | Example 3 | Example 4 | Example 5 |
|---|---|---|---|---|---|---|
| Spinning/ | Resin kind I | polyacetal | polyacetal | polyacetal | polyacetal | polyacetal |
| stretching | MFR | 9 | 31 | 9 | 9 | 9 |
| conditions | Value of A | −9.0 | −9.4 | −9.0 | −9.0 | −9.0 |
| | Tc′ (° C.) | 141 | 141 | 141 | 141 | 141 |
| | Resin kind II | PP | PP | PP | PP | HDPE |
| | MFR | 16 | 16 | 11 | 30 | 16.5 |
| | Fiber sectional shape | hollow | hollow | hollow | hollow | hollow |
| | | split type | split type | split type | split type | split type |
| | Yarn fineness (dtex) | 8.9 | 8.9 | 8.9 | 8.9 | 8.9 |
| | Spinning temperature (° C.) | 190 | 190 | 190 | 190 | 190 |
| | Spinnability | A | A | A | A | A |
| | Stretch ratio | 4.7 | 4.7 | 4.7 | 4.7 | 4.7 |
| | Stretching temperature (° C.) | 80 | 80 | 80 | 80 | 80 |
| Fiber | Single-yarn fineness (dtex) | 2.3 | 2.3 | 2.3 | 2.3 | 2.3 |
| properties | Tensile strength (cN/dtex) | 4.3 | 3.5 | 4.3 | 3.8 | 2.6 |
| | Elongation (%) | 37 | 74 | 42 | 32 | 37 |
| Sectional | Number of Splitting | 16 | 16 | 16 | 16 | 16 |
| shape | r/d | 0.97 | 1.00 | 0.97 | 0.97 | 0.97 |
| | Proportion of hollow (%) | 20.3 | 9.2 | 24.7 | 16.9 | 14.3 |
| | Degree of polyacetal | 28.9 | 60.2 | 28.9 | 25.1 | 25.8 |
| | exposure (%) | | | | | |
| Chemical | Ethanol | A | A | A | A | A |
| resistance | 10% aqueous sodium | A | A | A | A | A |
| | hydroxide solution | | | | | |
| Properties | Texture | A | A | A | A | A |
| of form | Air permeability | 35.1 | 16.5 | 39.9 | 25.0 | 48.5 |
| | | Comparative | Comparative | Comparative | Comparative | Comparative |
| | | Example 1 | Example 2 | Example 3 | Example 4 | Example 5 |
| Spinning/ | Resin kind I | PP | PET | polyacetal | polyacetal | polyacetal |
| stretching | MFR | 11 | — | 9 | 9 | 9 |
| conditions | Value of A | — | — | −10.1 | −10.1 | −10.1 |
| | Tc′ (° C.) | — | — | 145 | 145 | 145 |
| | Resin kind II | HDPE | PP | PP | PMP | PMP |
| | MFR | 16.5 | 30 | 11 | 85 | 85 |
| | Fiber sectional shape | hollow | hollow | hollow | hollow | solid |
| | | split type | split type | split type | split type | split type |
| | Yarn fineness (dtex) | 6.5 | 5.4 | 8.3 | 9.1 | 9.1 |
| | Spinning temperature (° C.) | 280 | 305 | 200 | 200 | 200 |
| | Spinnability | A | A | C | C | B |
| | Stretch ratio | 4.4 | 1.8 | — | — | 4.0 |
| | Stretching temperature (° C.) | 95 | 90 | — | — | 90 |
| Fiber | Single-yarn fineness (dtex) | 1.7* | 3.3 | — | — | 2.2 |
| properties | Tensile strength (cN/dtex) | 3.7 | 1.4 | — | — | 4.0 |
| | Elongation (%) | 42 | 49 | — | — | 45 |
| Sectional | Number of Splitting | 16 | 16 | 16 | 16 | 8 |
| shape | r/d | 1.00 | 0.97 | — | — | 0.97 |
| | Proportion of hollow (%) | 18.7 | 14.5 | — | — | — |
| | Degree of polyacetal | 26.8** | 35.0** | — | — | 27.3 |
| | exposure (%) | | | | | |
| Chemical | Ethanol | A | A | — | — | A |
| resistance | 10% aqueous sodium | A | C | — | — | A |
| | hydroxide solution | | | | | |
| Properties | Texture | A | A | — | — | B |
| of form | Air permeability | 68.2 | 104.4 | — | — | 62.3 |

*In terms of fiber diameter, corresponding to polyacetal/polyolefin fiber of 2.3 dtex.
*Degree of PP or PET exposure in fiber surface.

As is clear from Table 1, the splittable conjugate fibers of Examples 1 to 5 according to the invention, which comprises a polyacetal and a polyolefin, attain a lower air permeability and an excellent splittability compared to those of Comparative Examples 1 and 2, and also have been split to a higher degree even under the same conditions. Namely, the conjugate fibers of the Examples readily undergo splitting into finer fibers without necessitating a splitting treatment conducted under severe conditions as in conventional techniques. Because of this, even a nonwoven fabric having a relatively low basis weight can be treated for fiber splitting without disordering the texture. Consequently, the time period required for splitting treatment (e.g., a high-pressure liquid jet treatment) and the cost thereof can be considerably reduced.

Furthermore, the splittable conjugate fibers of Examples 1 to 5 according to the invention, which comprises a polyacetal and a polyolefin, show the same chemical resistance as the splittable conjugate fiber constituted of a combination of polyolefin resins (Comparative Example 1). Consequently, the conjugate fibers of the Examples can be advantageously used also in the field of industrial materials especially required to have chemical resistance, such as, e.g., battery separators, wipers, and filters. Furthermore, the splittable conjugate fibers of Examples 1 to 5 according to the invention, in each of which the Tc′ of the polyacetal is 144° C. or lower, have better spinnability than the conjugate fibers of Comparative Examples 3 and 4, which have the same section but have a Tc′ exceeding 144° C., and than the conjugate fibers of Comparative Example 5, which have a simpler section but have a Tc′ exceeding 144° C. Thus, splittable conjugate fibers capable of efficiently yielding microfibers through splitting can be produced with satisfactory productivity.

The present application is based on Japanese Patent Application No. 2007-73221 filed on Mar. 20, 2007 and Japanese Patent Application No. 2007-332295 filed on Dec. 25, 2007, and the contents are incorporated herein by reference.

### INDUSTRIAL APPLICABILITY

The invention provides with satisfactory productivity a splittable conjugate fiber excellent in splittability and chemical resistance, fibrous form and product each comprising the same. More particularly, the invention provides a splittable conjugate fiber suitable for use in, e.g., the field of industrial materials such as battery separators, wipers, and filters and the field of hygienic materials such as diapers and napkins, and to a fibrous form and a product each obtained from the conjugate fiber.

1. A splittable conjugate fiber comprising a polyacetal and a polyolefin, wherein the polyacetal satisfies the following numerical expression:
Tc′≦144° C.
[wherein Tc′ represents a crystallization temperature Tc (° C.) when cooling the polyacetal melted at 210° C. at a cooling rate of 10° C./min].

2. The splittable conjugate fiber of claim 1, wherein the polyolefin is polypropylene.

3. The splittable conjugate fiber of claim 1, wherein the polyolefin is polyethylene.

4. The splittable conjugate fiber of any claim 1, which has a hollow.

5. A fibrous form comprising microfibers having an average single-yarn fineness after splitting of smaller than 0.6 dtex, wherein the microfibers are obtained by splitting the splittable conjugate fiber of claim 1.

6. The fibrous form of claim 5, wherein 50% or more of the splittable conjugate fiber is split.

7. A product obtained using the fibrous form of claim 5.

8. A product obtained using the fibrous form of claim 6.
